(19) United States
(12) Patent Application Publication
(10) Pub. No.: US 2025/0263134 A1
(43) Pub. Date: Aug. 21, 2025

(54) VEHICLE FRONT STRUCTURE

(71) Applicant: TOYOTA JIDOSHA KABUSHIKI KAISHA, Aichi-ken (JP)

(72) Inventors: Fumihiko KISHIMA, Konan-shi (JP); Yusuke FUSHIMI, Numazu-shi (JP); Shoma UMEZU, Susono-shi (JP); Kaito OHTA, Susono-shi (JP)

(21) Appl. No.: 19/052,283

(22) Filed: Feb. 13, 2025

(30) Foreign Application Priority Data
Feb. 20, 2024 (JP) 2024-023439

(51) Int. Cl. B62D 35/00

(52) U.S. Cl. CPC B62D 35/00

(57) ABSTRACT

The traveling air flow is introduced into the inside of the vehicle body through the side grille opening formed at the side edge of the front bumper. The introduced air flow is guided by the side grille cover, side duct cover and side duct, and discharged from the side duct opening formed on the side of the front bumper. The inner guide surface and outer guide surface, which guide the air flow, are only partially disposed in the direction along the path of the air flow.

### CROSS REFERENCE TO RELATED APPLICATION

This application claims priority to Japanese Patent Application No. 2024-23439 filed on Feb. 20, 2024, which is incorporated herein by reference in its entirety including the specification, claims, drawings, and abstract.

### TECHNICAL FIELD

This invention relates to a vehicle front structure of, in particular, to the guidance of the airflow flowing inside the vehicle body.

### BACKGROUND

Japanese Patent Publication No. 2017-197125 describes an air flow straightening device for a vehicle. This straightening device guides the air flow introduced into the vehicle body through the first opening (14) provided in the front region of the vehicle (1) to the second opening (18) via the connecting path (16), and discharges the air flow from the second opening (18) in a direction away from the vehicle. The symbols in parentheses above are the symbols used in the above-mentioned document and are not related to the symbols used in the description of the embodiments of the present application.

### SUMMARY

When a traveling air flow hitting the front of a vehicle flows to the lateral direction away from a vehicle body, the air flow around the vehicle body becomes turbulent. When a duct-like guide is used to guide the air flow from an intake opening that introduces the air flow into the vehicle body to a discharge opening that discharges the air flow, resistance is generated due to the friction of the air flow with the guide. The object of the present disclosure is to suppress the disturbance of the air flow around the vehicle body and/or to reduce the resistance of the air flow inside the vehicle body.

The vehicle front structure according to this disclosure includes; a vehicle front region in which an intake opening is formed at a side end portion of the vehicle front region to introduce a flow of traveling air into a vehicle; a vehicle side region in which a discharge opening is formed to discharge the flow of air introduced into the vehicle; and a guide configured to guide an internal flow of air introduced from the intake opening to the discharge opening. The guide has an inner guide surface disposed on an inner side, in a vehicle width direction, of the guide and an outer guide surface disposed on an outer side, in the vehicle width direction, of the guide. At least one of the inner guide surface and the outer guide surface is disposed only in part between the inlet opening and the discharge opening in a direction along the internal flow.

The flow of traveling air is introduced into the vehicle from the vehicle front region, passes through the inside of the vehicle, and is discharged from the vehicle side region, thereby suppressing the generation of air flow that flows from the front of the vehicle to the laterally away from the vehicle. In addition, at least one of the outer guide surface and the inner guide surface is disposed only partially between the intake opening and the discharge opening in the direction along the internal flow, which reduces the contact area between the internal flow and the guide.

In the above-mentioned vehicle front structure, the discharge opening may have a elongated shape extending along the front edge of a wheel house opening in the vehicle side region. The elongated shape reduces the influence on the flow flowing along a side surface of the vehicle body.

In the above-mentioned vehicle front structure, the guide may be configured to guide the internal flow so that the air discharged from the discharge opening flows rearwardly along the vehicle side surface. The discharged air flow along the vehicle side surface, which reduces the turbulence in the air flow near the side of the vehicle.

In the above-mentioned vehicle front structure, the outer guide surface may have a restricting portion that guides the internal flow of air so as not flow toward the protruding structure provided on the backside of a surface member constructing a part of an outer surface of the vehicle body. This can reduce the resistance caused by the air flow hitting the protruding structure.

In the above-mentioned vehicle front structure, a dam structure may be provided on a part of the peripheral edge of the intake opening in the vehicle front region to prevent the flow of traveling air from flowing away from the vehicle front region. This can suppress the turbulence of the air flow around the vehicle body caused by the air flow flowing away from the vehicle and flowing laterally.

According to the present disclosure, a portion of the air flow from the front of the vehicle passes through the inside of the vehicle and is discharged from the side of the vehicle, thereby suppressing the turbulence of the air flow around the vehicle. Furthermore by disposing at least one of the outer guide surface and the inner guide surface only partially between the intake opening and discharge opening in the direction along the internal flow, the contact area between the internal flow and the guide is reduced, and the resistance acting on the internal flow is reduced.

### BRIEF DESCRIPTION OF DRAWINGS

Embodiment(s) of the present disclosure will be described based on the following figures, wherein:

FIG. 1 is a perspective view showing the general configuration of the front bumper as seen from outside the vehicle;

FIG. 2 is a perspective view showing the configuration of the side end of the front bumper as seen from inside the vehicle;

FIG. 3 is a perspective view showing the configuration of the rear edge of the front bumper as seen from the rear at an angle;

FIG. 4 is a perspective view of the front bumper sectioned horizontally;

FIG. 5 shows the configuration of the air flow path through the front bumper;

FIG. 6 shows another example of the internal flow path;

FIG. 7 shows another example of the internal flow path.

### DESCRIPTION OF EMBODIMENTS

An embodiment of the present disclosure will be described below with reference to the accompanying drawings. Hereinafter, the terms indicating positions, directions, and orientations, such as front, forward, rear, rearward, left, leftward, right, rightward, up, upward, down, downward, and the like denote relative positions, directions, and orientations with respect to the vehicle, unless otherwise specified. The side of a vehicle that is closer to the center line extending in the front-to-back direction of the vehicle in the left-right direction (width direction) is referred to as the inner side of the vehicle width direction, and the side that is further away from the center line is referred to as the outer side of the vehicle width direction, while a direction toward the centerline is referred to as an inward direction in the vehicle width direction, and a direction leaving away from the centerline is referred to as an outward direction. In each drawing, an arrow FR points forward, an arrow UP points upward, an arrow LH points leftward, and an arrow IN points inward in the vehicle width direction.

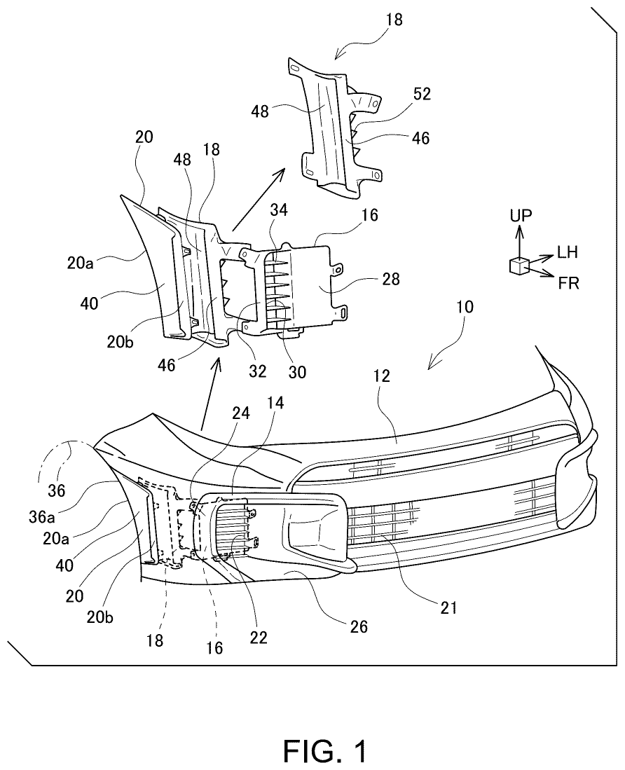

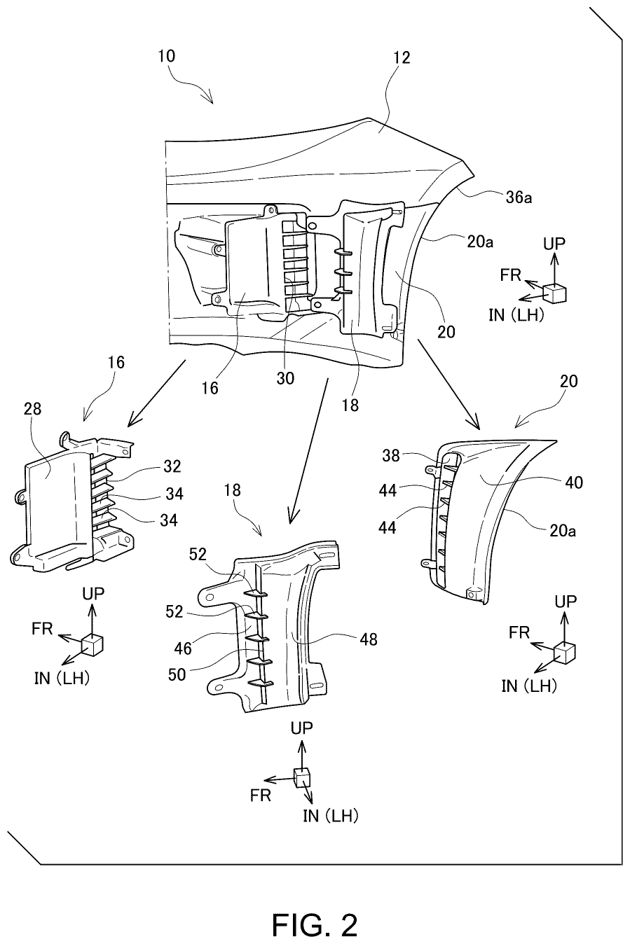

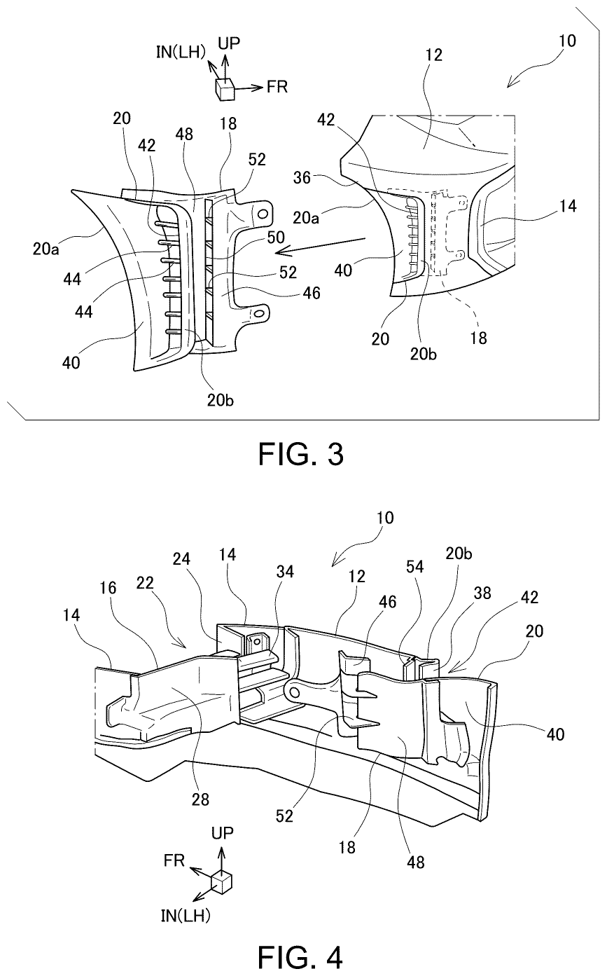

FIGS. 1-3 show a vehicle front structure, in particular a front bumper 10 of a passenger car. FIG. 1 shows a perspective view of the front bumper 10 as seen from the forward side of the vehicle. FIG. 2 shows a perspective view of the back side of the side end portion of the front bumper 10. FIG. 3 shows a perspective view of the side end portion of the front bumper 10 as seen from the rearward.

The front bumper 10 includes a bumper cover 12 that covers the front of the vehicle. In addition, the front bumper 10 includes a side grille 14, a side grille cover 16, a side duct cover 18, and a side duct 20, and these parts are attached to the bumper cover 12. The bumper cover 12, the side grille 14, the side grille cover 16, the side duct cover 18 and the side duct 20 may be made of plastic. FIGS. 1 to 3 show the front bumper 10 in its entirety, as well as the side grille cover 16, the side duct cover 18 and the side duct 20 removed from the bumper cover 12.

The bumper cover 12 covers the front of vehicle front region and also covers the side of vehicle front region by curving around from the front. The part of the bumper cover 12 that covers the side of vehicle front region constitutes a part of the fender. A radiator grille 21 is provided in the center of the bumper cover 12 in the vehicle width direction. On either side of the radiator grille 21 on the bumper cover 12, a side grille 14 is provided. The side grille 14 has side grille openings 22 formed in them to allow some of the travelling air flow that the front bumper 10 receives to be introduced into the vehicle body. The side grille opening 22 is an intake opening that introduces the traveling air flow into the vehicle body. The side grille 14 has a wall-like structure 24 that is extended forward and is attached to part of the circumference of the side grille opening 22. This wall-like structure 24 is a dam structure that prevents the traveling air flow received at the front of the vehicle body from flowing to the sideward. Hereinafter, this wall-like structure 24 is referred to as the dam structure 24. The dam structure 24 may be provided on the outer side edge, in the vehicle width direction and upper side edge of the side grille opening 22, in particular. The bumper cover 12 may have a front spoiler 26 that extends forward from the lower edge of the bumper cover 12. The part of the front spoiler 26 that extends forward from the lower edge of the side grille opening 22 works with the dam structure 24 to guide the travelling air flow into the side grille opening 22.

The side grille cover 16 is positioned on the back side of the bumper cover 12 to correspond to the side grille opening 22. The side grille cover 16 has a cover plate 28 arranged to cover most of the side grille opening 22. The side grille cover 16 further has a grill cover opening frame 32 that defines a grill cover opening 30 in cooperation with the outer edge of the cover plate 28 in vehicle width direction. The grill cover opening 30 is a vertically elongated opening formed in the outer end portion of the side grille cover 16 in vehicle width direction. The cover plate 28 is a blind that prevents the internal structure of the vehicle from being seen through the side grille opening 22. In addition, the front surface of the cover plate 28 is a guide surface that directs the air flow introduced through the side grille opening 22 to the grille cover opening 30.

The grill cover opening 30 is provided with grill cover flow-straightening plates 34, the ends of which are respectively connected to the cover plate 28 and the grill cover opening frame 32. The grill cover flow-straightening plates 34 are arranged along the longitudinal direction of the grill cover opening 30, and each grill cover flow-straightening plate 34 is disposed approximately horizontally. The grill cover flow-straightening plates 34 straighten the air flow passing through the side grill openings 22.

The side duct 20 forms the exterior surface of the front bumper 10 in cooperation with the bumper cover 12. The side duct 20 is part of the fender that covers a front wheel (not shown), and the rear edge 20a of the side duct 20 defines part of a front edge 36a of a wheel house opening 36. The side duct 20 is arranged so that an exterior surface 20b of the front end of the side duct 20 is flush with an exterior surface of the part of the bumper cover 12 that is located forward of the side duct 20. The side duct 20 has a duct outer plate 38 and a duct inner plate 40. A duct opening 42 is formed between the duct outer plate 38 and the duct inner plate 40 (see FIG. 4). The duct opening 42 is a discharge opening that discharges the air flow flowing inside the vehicle body to the outside of the vehicle body. The duct outer plate 38 is located outer side of the air flow passing through the duct opening 42 in the vehicle width direction. A surface of the duct outer plate 38 that faces the air flow is a guide surface that guides the air flow. The duct inner plate 40 is located inner side the air flow passing through the duct opening 42 in the vehicle width direction. A surface of the duct inner plate 40 that faces the air flow is a guide surface that guides the air flow. This guide surface is curved in an approximately convex shape in the direction along the air flow.

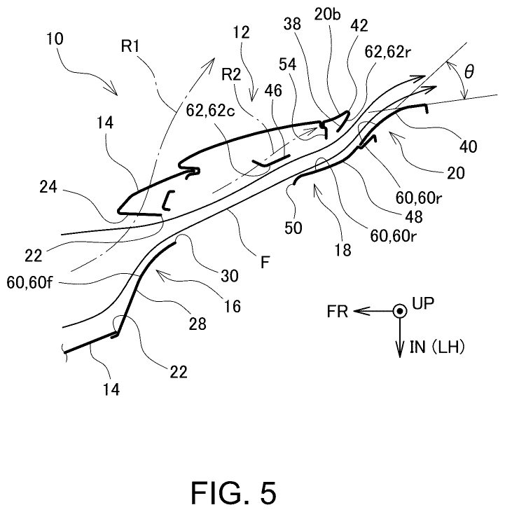

The duct outer plate 38 is connected to the exterior surface 20b of the front end of the side duct 20 at its rear edge (see FIGS. 4 and 5). The duct inner plate 40 is arranged so that it is flush with a part of the adjacent bumper cover 12 in the vertical direction at its rear edge. The duct opening 42 is an opening located at the front end of the side duct 20. The duct opening 42 is an elongated opening that extends in the vertical direction or in the direction along the front edge 36a of the wheel house opening. The duct opening 42 is provided with duct flow-straightening plates 44, the left and right ends of which are respectively coupled to the duct inner plate 40 and the duct outer plate 38. The duct flow-straightening plates 44 are arranged along the longitudinal direction of the duct opening 42, and each duct flow-straightening plate 44 is disposed approximately horizontally. The duct flow-straightening plates 44 straighten the air flow passing through the duct opening 42.

The side duct cover 18 is located on the back of the bumper cover 12. The side duct cover 18 is positioned forward of the side duct 20, so that part of it overlaps with the side duct 20. Furthermore, the side duct cover 18 is positioned with a gap between it and the side grille cover 16. The side duct cover 18 has a duct cover outer plate 46 and a duct cover inner plate 48. A duct cover opening 50 is formed between the duct cover outer plate 46 and the duct cover inner plate 48. The air flow introduced through the side grille opening 22 is guided towards the duct opening 42 by the duct cover opening 50. The duct cover outer plate 46 is located outer side of the air flow passing through the duct cover opening 50 in the vehicle width direction. The surface of the duct cover outer plate 46 facing the air flow is a guide surface that guides the air flow. The duct cover inner plate 48 is located inside the air flow passing through the duct cover opening 50 in the vehicle width direction. The surface of the duct cover inner plate 48 facing the air flow is a guide surface that guides the air flow. This guide surface is curved in an approximately concave shape in the direction along the air flow.

The duct cover opening 50 is an elongated opening in the vertical direction. The duct cover opening 50 is provided with duct cover flow-straightening plates 52, the left and right edges of which are respectively connected to the duct cover inner plate 48 and the duct cover outer plate 46. The duct cover flow-straightening plates 52 are arranged along the longitudinal direction of the duct cover opening 50, and each duct cover flow-straightening plate 52 is disposed approximately horizontally. The duct cover flow-straightening plates 52 straighten the air flow passing through the duct cover opening 50.

The duct cover outer plate 46 guides the air flow so that it does not flow into the protruding structure 54 (see FIG. 5) on the back side of the bumper cover 12. The duct cover outer plate 46 also guides the air flow toward the duct opening 42. The duct cover outer plate 46 is separated from the duct outer plate 38 of the side duct 20. The duct cover inner plate 48 is connected to the front edge of the duct inner plate 40 at its rear edge. As a result, the duct cover inner plate 48 and the duct inner plate 40 define a continuous guide surface. In addition, the duct inner plate 40 and the duct cover inner plate 48 cover the internal structure of the vehicle so that the internal structure cannot be seen from the outside. In particular, the duct cover inner plate 48 is a blind that prevents the internal structure of the vehicle from being seen through the duct opening 42.

FIGS. 4 and 5 illustrate the path of the air flow F introduced into the inside of the vehicle body through the side grille opening 22 and discharged from the duct opening 42, and the structure that defines the path of the air flow F. FIG. 4 shows the front bumper 10 sectioned in a horizontal plane. FIG. 5 is a sectional view of the front bumper 10 in a horizontal plane. In FIG. 5, the air flow F passing through the inside of the side end portion of the front bumper 10 is indicated by a solid arrow.

A portion of the traveling air flow that the front of the front bumper 10 receives is guided into the side grille opening 22. The portion of the air flow that the front of the front bumper 10 receives tends to flow laterally, as indicated by the dotted-line arrow R1. This flow leaves the side of the vehicle body and causes the flow around the vehicle body to become turbulent. The dam structure 24 of the side grille 14 blocks this lateral flow. The side grille 14 guides the traveling air flow into the side grille opening 22. The side grille cover 16 is located behind the side grille opening 22. The air flow that meets the cover plate 28 of the side grille cover 16 flows along the surface of the cover plate 28 to the outer side of the vehicle width direction and enters the inside of the front bumper 10 through the grille cover opening 30.

Furthermore, the air flow F flows towards the duct cover opening 50 of the side grille cover 16. The air flow that flows towards the outer side of the vehicle width, as indicated by the arrow R2, is directed inward by the duct cover outer plate 46. The duct cover outer plate 46 prevents the air flow from hitting the protruding structure 54 provided on the back surface of the bumper cover 12. This prevents an increase in air resistance. The protruding structure 54 may be, for example, a rib provided for reinforcing the bumper cover 12, or it may be a pedestal for attaching another component to the bumper cover 12. After passing through the duct cover opening 50, the air flow is guided to the duct opening 42 by the duct cover inner plate 48 and the duct inner plate 40, and is discharged from the vehicle body through the duct opening 42.

The air flow F introduced into the inside of the front bumper 10 through the side grille opening 22 is guided by the side grille cover 16, the side duct cover 18 and the side duct 20 and discharged from the duct opening 42. The side grille cover 16, the side duct cover 18 and the side duct 20 are guides that guide the air flow (internal air flow) inside the front bumper 10. More specifically, the air flow F is guided by the cover plate 28, the duct cover inner plate 48, and the duct inner plate 40, which are located inner side of the air flow F in the vehicle width direction. The surfaces of the cover plate 28, the duct cover inner plate 48, and the duct inner plate 40 that face the air flow F constitute the inner guide surface 60 that guides the air flow F. Meanwhile, the surfaces of the duct cover outer plate 46 and the duct outer plate 38 that are located on the outer side of the air flow F in the vehicle width direction constitute the outer guide surface 62 that guides the air flow F.

In the direction along the air flow F, the inner guide surface 60 is disposed only partially between the side grille opening 22 and the duct opening 42. Specifically, the inner guide surface 60 includes a front section 60f that connects to the edge of the side grille opening 22 and a rear section 60r that connects to the edge of the duct opening 42, and the front section 60f and the rear section 60r are spaced apart. In other words, the inner guide surface 60 is not provided between the front section 60f and rear section 60r. The front section 60f of the inner guide surface 60 is defined by the cover plate 28, and the rear section 60r is defined by the duct cover inner plate 48 and the duct inner plate 40.

The outer guide surface 62 is also disposed only in part between the side grille opening 22 and the duct opening 42. Specifically, the outer guide surface 62 includes a rear section 62r that connects to the edge of the duct opening 42 and a central section 62c that is separated from both the side grille opening 22 and the rear section 62r. The outer guide surface 62 is not provided in the area between the central section 62c and the rear section 62r, and is not provided in the area forward of the central section 62c. The central section 62c of the outer guide surface 62 is defined by the duct cover outer plate 46. The central section 62c is a restriction section that prevents the air flow F from reaching the protruding structure 54 on the back side of the bumper cover 12. The rear section 62r of the outer guide surface 62 is defined by the duct outer plate 38.

By not providing guide surfaces 60, 62 in some areas in the direction along the air flow F, a contact area between the air flow and the guide surfaces 60, 62 is reduced, and friction is reduced. As a result, the air resistance of the vehicle is reduced.

In a horizontal plane, an angle θ between the outer surface of the front bumper 10 around the duct opening 42 and the part of the outer guide surface 62 leading to the duct opening 42 may be 40° or less. Setting the angle θ to 40° or less causes the airflow discharged from the duct opening 42 and directed rearwards flows along the side surface of the vehicle body. As a result, the turbulence of the air flow around the vehicle body is suppressed, and air resistance is reduced. The angle θ may also be set to 30 to 40°.

Furthermore, because the duct opening 42 is an elongated opening, the air flow discharged from the duct opening 42 becomes a uniform air flow that is dispersed in the vertical direction. As a result, the turbulence of the air flow flowing near the side of the vehicle body is suppressed.

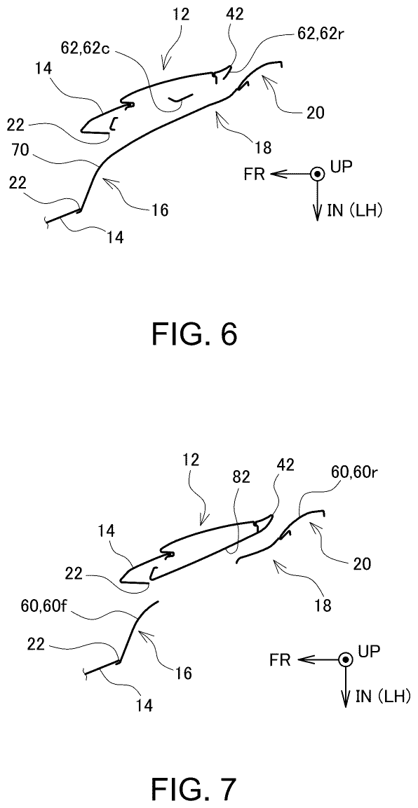

FIGS. 6 and 7 show other embodiments of the guide surface. The embodiment shown in FIG. 6 is an example in which an inner guide surface 70 that extends from the side grille opening 22 to the duct opening 42 is disposed in place of the inner guide surface 60 of the embodiment shown in FIG. 5. The continuous inner guide surface 70 may be formed by extending either or both of the cover plate 28 of the side grille cover 16 and the duct cover inner plate 48 of the side duct cover 18. The outer guide surface 62 is only partially disposed in the direction along the air flow, and the flow resistance is reduced.

The embodiment shown in FIG. 7 is an example in which an outer guide surface 82 that extends continuously from the side grille opening 22 to the duct opening 42 is disposed in place of the outer guide surface 62 of the embodiment shown in FIG. 5. The continuous outer guide surface 82 may be formed by extending the duct cover outer plate 46 of the side duct cover 18 forward and backward. The inner guide surface 60 is only disposed in part in the direction along the air flow, reducing flow resistance.

The above explains the structure of the right-hand end of the front bumper 10, but the left-hand end has a structure that is symmetrical to the right-hand end.

### REFERENCE SIGNS LIST

10 Front bumper (Front body structure)
12 Bumper cover
14 Side grille
16 Side grille cover
18 Side duct cover
20 Side duct
22 Side grille opening (Intake opening)
24 Dam structure
28 Cover plate
30 Grille cover opening
36 Wheelhouse opening
36a Front edge of wheelhouse opening
38 Duct outer plate
40 Duct inner plate
42 Duct opening (Discharge opening)
46 Duct cover outer plate
48 Duct cover inner plate
50 Duct cover opening
54 Convex structure
60, 70 Inner guide surface
62, 82 Outer guide surface
F Air flow.

1. A vehicle front structure comprising:
a vehicle front region in which an intake opening is formed at a side end portion of the vehicle front region to introduce a flow of traveling air into a vehicle;
a vehicle side region in which a discharge opening is formed to discharge the flow of air introduced into the vehicle; and
a guide configured to guide an internal flow of air introduced from the intake opening to the discharge opening, the guide having an inner guide surface disposed on an inner side, in a vehicle width direction, of the guide and an outer guide surface disposed on an outer side, in the vehicle width direction, of the guide,
wherein at least one of the inner guide surface and the outer guide surface is disposed only in part between the inlet opening and the discharge opening in a direction along the internal flow.

2. The vehicle front structure according to claim 1, wherein the discharge opening has an elongated shape extending along a front edge of a wheel house opening in the vehicle side region.

3. The vehicle front structure according to claim 2, wherein the guide is configured to guide the internal flow so that the air discharged from the discharge opening flows rearwardly along a vehicle side surface.

4. The vehicle front structure according to claim 1, wherein the outer guide surface has a restricting portion designed to guide the internal flow of air so as not to flow toward a protruding structure provided on the backside of a surface member constituting a part of an outer surface of the vehicle body.

5. The vehicle front structure according to claim 1, wherein a dam structure is provided to a part of a peripheral edge of the intake opening in the vehicle front region to prevent the flow of traveling air from flowing away from the vehicle front region.
